(19) United States
(12) Patent Application Publication
(10) Pub. No.: US 2023/0407168 A1
(43) Pub. Date: Dec. 21, 2023

(54) SYNTHETIC POLYMERS HAVING IMPROVED PHOTOSTABILITY THROUGH THE INCORPORATION OF INORGANIC PHOSPHORS

(71) Applicant: THE BOEING COMPANY, Arlington, VA (US)

(72) Inventor: John N. Harris, Seattle, WA (US)

(21) Appl. No.: 18/326,347

(22) Filed: May 31, 2023

Related U.S. Application Data
(60) Provisional application No. 63/366,582, filed on Jun. 17, 2022.

(51) Int. Cl. C09K 11/02; C09K 11/77; C08K 3/34; C08K 3/38; C08J 3/20

(52) U.S. Cl. CPC C09K 11/02; C09K 11/77742; C09K 11/774; C08K 3/34; C08K 3/38; C08J 3/201; C08K 2003/343; C08K 2003/387; C08K 2201/014; C08J 2327/14

(57) ABSTRACT

Described herein are methods for improving the color stability of a synthetic polymer composition by incorporating one or more inorganic phosphor dopants into the synthetic polymer. The inorganic phosphor dopants absorb UV light and emit the UV light as down-converted visible light, thereby producing a brighter appearance for the synthetic polymer composition. Methods for preparing the synthetic polymer compositions having improved color stability are additionally described.

### CROSS-REFERENCE TO RELATED APPLICATIONS

This application claims priority to U.S. Provisional Patent Application No. 63/366,582, filed on Jun. 17, 2022, the contents of which is hereby incorporated by reference in its entirety.

### FIELD

The presently disclosed subject matter relates generally to methods for improving the color stability of synthetic polymers.

### BACKGROUND

Phosphor materials have the properties of emitting ultraviolet, visible, and infrared light by action of external exciting means such as irradiation of electromagnetic waves (e.g., electron beams, X-rays, ultraviolet rays, visible light, etc.) or application of an electric field, and therefore are used in a large number of photoelectric transducers or photoelectric conversion devices. Examples of such devices are light-emitting devices, including white light-emitting diodes, fluorescent lamps, electron beam tubes, plasma display panels, inorganic electroluminescent displays, and scintillators. Inorganic phosphors, in particular, have been extensively explored to meet the demand of low voltage stimulated lighting sources owing to increased global energy consumption. Due to their environmental friendliness, advantages of long lifetime, lower energy consumption, reliability, and high luminous efficiency, modern white light-emitting diodes (WLEDs) have replaced less effective incandescent and mercury-enclosing conventional fluorescent lighting sources.

The lanthanides are often used as phosphors for luminescence applications. For example, praseodymium's shielded f-orbitals allow for long excited state lifetimes and high luminescence yields. Indeed, Pr³⁺ is often a dopant ion for use in red, blue, green, and ultraviolet phosphors.

### BRIEF SUMMARY

In one aspect, the presently disclosed subject matter is directed to a method for improving color stability of a synthetic polymer composition, comprising: exposing a synthetic polymer host material comprising one or more inorganic phosphor dopants to UV light; wherein the one or more inorganic phosphor dopants in the synthetic polymer host material absorb the UV light and then emit the UV light as down-converted visible light.

In another aspect, the presently disclosed subject matter is directed to a synthetic polymer composition comprising: a synthetic polymer host material comprising one or more inorganic phosphor dopants, wherein the one or more inorganic phosphor dopants in the synthetic polymer host material emit down-converted visible light upon exposure to UV light; and wherein the synthetic polymer composition exhibits mechanical and flammability properties comparable to that of a synthetic polymer composition without the one or more inorganic phosphor dopants.

In another aspect, the presently disclosed subject matter is directed to a method for preparing a synthetic polymer composition comprising: contacting a synthetic polymer host material with one or more inorganic phosphor dopants to prepare an inorganic phosphor-doped synthetic polymer material, wherein the one or more inorganic phosphor dopants in the inorganic phosphor-doped synthetic polymer material are capable of absorbing UV light and then emitting the UV light as down-converted visible light.

These and other aspects are described fully herein.

### BRIEF DESCRIPTION OF THE DRAWINGS

FIG. 1a shows a process for preparing an inorganic phosphor-doped synthetic polymer material according to methods described herein.

FIG. 1b shows a process for creating a brighter appearance for an object by applying inorganic phosphor-doped synthetic polymer materials described herein.

FIG. 2a shows a process for creating a brighter appearance for an object by applying inorganic phosphor-doped synthetic polymer materials described herein.

FIG. 2b shows a process for creating a brighter appearance for an object by applying inorganic phosphor-doped synthetic polymer materials described herein.

FIG. 3 shows exemplary excitation and emission spectra for inorganic phosphor dopants.

FIG. 4 shows how white light can be created by blending blue, green, and red emitted light.

FIG. 5 shows an exemplary lattice structure of a doped solid state material (i.e. inorganic phosphor dopant).

### DETAILED DESCRIPTION

The subject matter described herein relates to methods for improving the color stability of synthetic polymer materials by applying the inherent luminescent properties of inorganic rare earth phosphors.

Synthetic polymers, such a thermoplastics, will typically undergo photo-oxidation when exposed to UV light in the presence of oxygen. When polymers absorb this UV radiant energy, it can lead to bond breakage because the energy of the UV light is greater than the dissociation energy for the carbon-carbon sigma bonds in the synthetic polymer. Indeed, UV light, such as UV-C light, has a wavelength ranging from 200 nm to 280 nm with photon energies ranging from 6.2 eV to 4.4 eV. Conversely, the bond energy of a typical carbon-carbon sigma bond is only 3.8 eV. As such, the absorption of UV-C light in the presence of oxygen can lead to bond dissociation oxidation, which results in changes in the molecular structure of the polymer. This change in structure is often accompanied by undesired visible changes in the polymer, such as discoloration (yellowing) and embrittlement.

Current solutions to address the discoloration and embrittlement often experienced by synthetic polymers exposed to UV light include: (1) using polymers with greater color stability in applications where there is high UV light exposure; and/or (2) incorporating UV-stabilizing additives into synthetic polymer formulations. However, the synthetic polymers that exhibit satisfactory color stability can lack appropriate mechanical properties, such as impact durability and chemical resistance. Further, the additives used to improve color stability in synthetic polymers often reduce the material's mechanical properties, such as tensile strength. Such additives have also been shown to reduce the material's flammability properties. As such, there is a need in the art to stabilize the color of synthetic polymers being exposed to UV light without reducing other material performance properties.

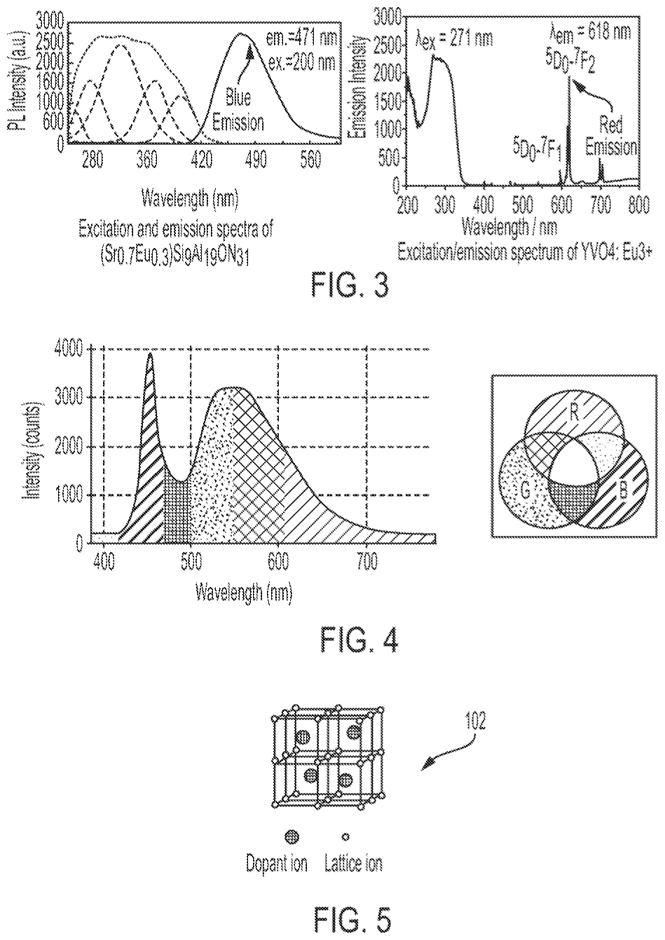

The subject matter described herein overcomes the limitations of the art by incorporating inorganic phosphors into the synthetic polymer composition. The inorganic phosphors absorb UV light (103) and convert it to harmless visible light (104). The inorganic phosphors applied in the methods and compositions described herein are crystalline materials, having a lattice structure that imparts high photostability, as depicted by the exemplary lattice structure of FIG. 5. The regular and rigid arrangement of atoms in the lattice equips the phosphor with enhanced thermostability, for example. In these phosphors, a small percentage of metal “dopant” ion is incorporated into the lattice that will impact the excitation and emission properties of the phosphor. As used herein, an inorganic phosphor dopant (102) refers to a rare earth ion (107) or transition metal-containing metal oxide or metal fluoride material. In certain examples, the synthetic polymer composition comprises about 0.05% to about 10% weight or about 0.05% to about 5% weight of inorganic phosphor dopant. In certain other examples, the synthetic polymer composition comprises about 0.05% to about 0.15%, about 0.10% to about about 0.15% to about 3%, about 0.25% to about 4%, about 1% to about 5%, about 1.5% to about 3.5%, about 2.5% to about 4%, about 0.50% to about 4.5%, about 4 to about 5%, about 5% to about 10%, about 3% to about 7%, about 4% to about 8%, about 6% to about 9%, or about 7% to about 10% weight of inorganic phosphor dopant. Since the inorganic phosphor materials are ceramic-type materials, there is no adverse impact on the mechanical or flammability properties of the synthetic polymer host material (101). Many phosphors strongly absorb (high energy; short wavelength) UV light (103), which is accompanied by an emission of light at longer wavelengths and lower energy than what the phosphor originally absorbed. This emission is typically in the visible range, which is not destructive to synthetic polymers. The process of light absorption at one wavelength, followed by emission at a longer wavelength is known as “down conversion.” The inorganic phosphors in the synthetic polymers described herein absorb high energy UV light (180 nm-360 nm) and emit that energy as “down-converted” visible light (200 nm-700 nm) as demonstrated by the exemplary excitation and emission spectra for example inorganic phosphors in FIG. 3.

As described herein, the color of the emitted light energy can be tailored by incorporating different metal ions into the metal oxide (106) or metal fluoride (109) host lattice. Combinations of different emitted light colors will yield white/off-white colored light. For example, blue-yellow or blue-green-red emitter combinations afford white/off-white emission. Such light emission combinations from phosphors can be used to tailor the visual color of solids.

The subject matter described herein manages the impact of UV light on synthetic polymers through the selective incorporation of inorganic phosphors to absorb and down convert visible light to provide a brighter appearance to the synthetic polymer material. The brighter appearance is a perceived brightness by a viewer.

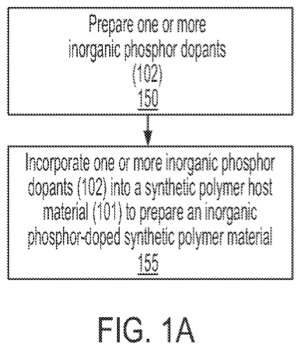

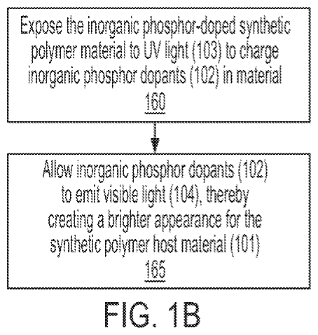

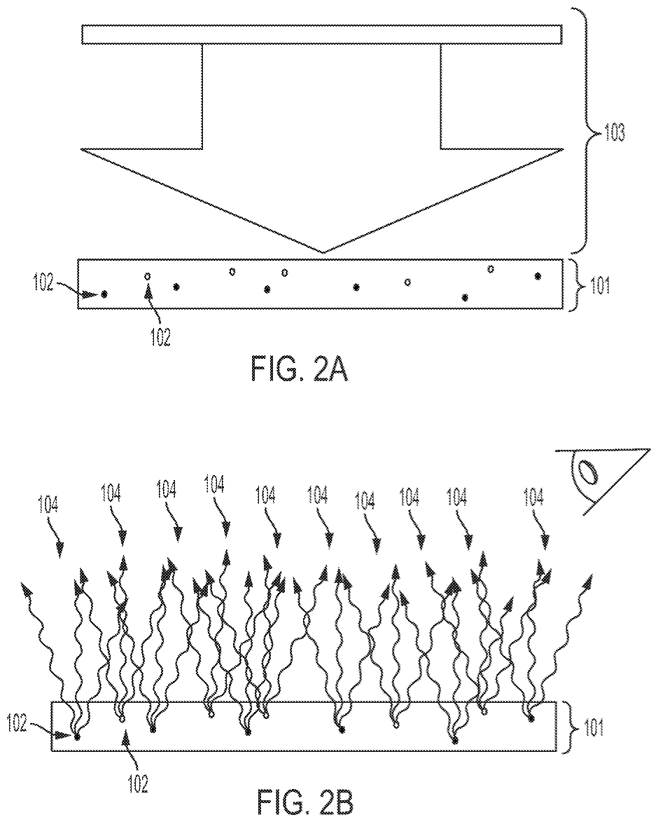

FIGS. 1b, 2a, and 2b show exemplary processes for creating a brighter appearance for an object by applying inorganic phosphor-doped synthetic polymer materials described herein. Briefly, as shown in FIG. 1a, one or more inorganic phosphor dopants (102) are prepared in Step 150 and the one or more inorganic phosphor dopants (102) are incorporated into a synthetic polymer host material (101) to prepare an inorganic phosphor-doped synthetic polymer material as depicted in Step 155. As shown in FIGS. 1b and 2a, the inorganic phosphor-doped synthetic polymer material is exposed to UV light to charge the inorganic phosphor dopants in the material in Step 160. The shaded and light inorganic phosphor dopants represent two different types of dopants, each of which emits visible light at different wavelengths. Once the inorganic phosphor dopants are charged in FIG. 2a, the UV light is removed and the inorganic phosphor dopants emit visible light, thereby creating a brighter appearance for the synthetic polymer host material as depicted in FIG. 2b and Step 165 of FIG. 1b. In this example, the synthetic polymer host material comprises two different inorganic phosphor dopants, which emit different wavelengths of light, but combine to form white light. The brighter appearance of the synthetic polymer host material can be visually perceived by a viewer (illustrated by the eye shown in FIG. 2b).

The presently disclosed subject matter will now be described more fully hereinafter. However, many modifications and other examples of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to specific examples disclosed and that modifications and other examples are intended to be included within the scope of the appended claims. In other words, the subject matter described herein covers all alternatives, modifications, and equivalents. Unless otherwise defined, all technical and scientific terms used herein have the same meaning as commonly understood by one of ordinary skill in this field. All publications, patent applications, patents, and other references mentioned herein are incorporated by reference in their entirety. In the event that one or more of the incorporated literatures, patents, and similar materials differs from or contradicts this application, including but not limited to defined terms, term usage, described techniques, or the like, this application controls.

### I. Definitions

As used herein, “and/or” refers to and encompasses any and all possible combinations of one or more of the associated listed items, as well as the lack of combinations when interpreted in the alternative (“or”).

The terms “approximately,” “about,” “essentially,” and “substantially” as used herein represent an amount close to the stated amount that still performs a desired function or achieves a desired result. For example, in some examples, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic.

As used herein, conditional language used herein, such as, among others, “can”, “could”, “might”, “may”, “e.g.”, and the like, unless specifically stated otherwise or otherwise understood within the context as used, is generally intended to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example. The terms, “consisting of”, “consist of”, and “consists of”, respectively, and the like are synonymous and used in a close-ended fashion, and exclude additional elements, features, acts, operations, and so forth. The terms “consisting essentially of”, “consist essentially of”, “consists essentially of” and the like are synonymous and semi-closed terms that indicate an item in the claim is limited to the components specified in the claim and those that do not materially affect the basic and novel characteristics of the claim. Additionally, the term “or” is used in its inclusive sense (and not in its exclusive sense) so that when used, for example, to connect a list of elements, the term “or” means one, some, or all of the elements in the list.

As used herein, “contacting” refers to contacting a synthetic polymer host material (101) with an inorganic phosphor dopant (102) to prepare an inorganic phosphor-doped synthetic polymer material. In examples, such contacting can be referred to as “compounding,” in which synthetic plastics are melted and mixed with additive materials (i.e. inorganic phosphor dopants) to prepared modified polymers. The synthetic polymer acts as a host material, wherein the inorganic phosphor dopant (102) is, as shown in FIG. 1a, incorporated into the host material through, for example, application of heat and/or pressure.

As used herein, “improving color stability” refers to extending the color lifespan of a synthetic polymer host material (101) and/or reducing the incidence of yellowing of the synthetic polymer host material (101) caused by exposure to UV light (103). As described herein, inorganic phosphor dopants (102) in the synthetic polymer material can absorb UV light (103), thereby reducing the impact that UV absorption has on polymer color stability. In examples, the inorganic phosphor dopants (102) absorb more incident UV light (103) than the synthetic polymer host material (101), thereby offsetting photo-oxidation and discoloration of the polymer material.

Such improved color stability can be visually measured using a control synthetic polymer that did not undergo UV exposure (“control”), a synthetic polymer that underwent UV exposure (“standard”), and a synthetic polymer comprising one or more inorganic phosphor dopants (“test”), as described herein, that also underwent UV exposure. Color changes can be readily perceived by comparing any amount of color change between the control, standard, and test samples. For example, a synthetic polymer comprising one of more inorganic phosphor dopants (test sample) is said to have improved color stability if it exhibits no or significantly less yellowing compared with the standard sample that also underwent UV exposure. Both the standard and test are compared with the control to visualize any changes in color.

Additionally, different phosphors can be mixed in the synthetic polymer host material (101) to emit white or off-white visible light (104), thereby creating a brighter appearance of the polymer material. The concept behind generating white light by mixing phosphors that emit light at different wavelengths is analogous to that observed in generating white light using LEDs, such as demonstrated in FIG. 4. For example, a conventional white light source can be realized by mixing red light, green light and blue light with a suitable intensity ratio. Alternatively, a white light source can be realized by mixing yellow light and blue light with a suitable intensity ratio. Examples are provided herein where phosphors are selected and incorporated into a synthetic polymer material to emit light of different colors that then combine to produce white light.

As used herein, “white light” refers to a combination of all wavelengths of electromagnetic radiation in the visible range of the spectrum, where each wavelength is present in an equal amount relative to the other wavelengths. “Off-white” light refers to combinations of wavelengths in the visible range of the electromagnetic radiation that are close to white light, but are not present in equal amounts, for example.

As used herein, “photo-oxidation” refers to degradation of a polymer surface due to the combined action of light and oxygen. Photo-oxidation causes the polymer chains to break, resulting in the material becoming increasingly brittle.

As used herein, the terms “inorganic phosphor dopant” and “phosphor” can be used interchangeably.

### II. Method for Improving the Color Stability of a Synthetic Polymer

In certain examples, the subject matter described herein is directed to a method for improving color stability of a synthetic polymer composition, comprising:
exposing a synthetic polymer host material (101) comprising one or more inorganic phosphor dopants (102) to UV light (103);
wherein the one or more inorganic phosphor dopants (102) in the synthetic polymer host material (101) absorb the UV light (103) and then emit the UV light as down-converted visible light (104).

When a phosphor is exposed to radiation, the orbital electrons in its atoms are excited to a higher energy level; when they return to their former level they emit the energy as light of a certain color. Indeed, the scintillation process in inorganic materials is due to the electronic band structure found in the crystals. An incoming particle can excite an electron from the valence band to either the conduction band or the exciton band (located just below the conduction band and separated from the valence band by an energy gap). This leaves an associated hole behind, in the valence band. Impurities create electronic levels in the forbidden gap. The excitons are loosely bound electron-hole pairs that wander through the crystal lattice until they are captured as a whole by impurity centers. The latter then rapidly de-excite by emitting scintillation light (i.e. a photon). The wavelength emitted is dependent on the atom itself and on the surrounding crystal structure.

As described herein, the one or more inorganic phosphor dopants (102) in the synthetic polymer host material (101) absorb UV light (103) and emit that UV light as down-converted visible light (104). In certain examples, the UV light (103) used to excite (charge) the orbital electrons of the inorganic phosphor dopant (102) has a wavelength between about 160 nm and 380 nm. In other examples, the UV light (103) has a wavelength between about 160 nm and 320 nm, about 160 nm and 260 nm, about 160 nm and 200 nm, about 180 nm and 240 nm, about 200 nm and 250 nm, about 250 nm to 380 nm, about 210 nm and 250 nm, about 225 nm and 260 nm, about 230 nm and 250 nm, or about 190 nm and 260 nm. In certain other examples, the UV light (103) has a wavelength of about 222 nm, 254 nm, or 275 nm.

Nonlimiting examples of UV light sources used to provide the UV light (103) in the above method include, for example, a black light, a short-wave ultraviolet lamp, an incandescent lamp, a deuterium lamp, a gas-discharge lamp, an ultraviolet LED, a pulsed Xenon light, and an ultraviolet laser. For example, the UV light source can be a pulsed Xenon-ultraviolet device in the form of a handheld wand. The wand can be held at a distance of 1 to 5 inches, for example, from the surface of a material comprising one or more inorganic phosphor dopants (102), wherein the one or more inorganic phosphor dopants (102) in the synthetic polymer host material (101) absorb the UV light (103). In another example, the UV light source used to provide the UV light (103) is a deuterium lamp, which has a range of light from about 185 nm to about 400 nm.

Other excitation energy sources, in addition to UV light, may be used in the methods described herein. Personal Protection Equipment (PPE) may be required for operating such energy sources.

In certain examples of the above method for improving color stability of a synthetic polymer composition, the absorption of the UV light (103) by the one or more inorganic phosphor dopants (102) reduces photo-oxidation of the synthetic polymer host material (101). As used herein, reducing photo-oxidation of the synthetic polymer host material (101) refers to the reduction in discoloration and/or embrittlement of the synthetic polymer host material (101) upon exposure to UV light (103) because the inorganic phosphor dopants (102) in the synthetic polymer host material (101) absorb most of the UV light (103) instead of the synthetic polymer host material (101), itself. The specific reduction in photo-oxidation is material-dependent, given the different behaviors in UV absorption among synthetic polymers. The inorganic phosphor dopants (102) typically exhibit a very intense absorption. As such, incorporation of the one or more inorganic phosphor dopants (102) into the synthetic polymer host material (101) can reduce photo-oxidation of the synthetic polymer host material (101) by up to 1%, 2%, 3%, 4%, 5%, 6%, 7%, 8%, 9%, 10%, 11%, 12%, 13%, 14%, 15%, 16%, 17%, 18%, 19%, 20%, 25%, 26%, 27%, 28%, 29%, 30%, 31%, 32%, 33%, 34%, 35%, 36%, 37%, 38%, 39% 40%, 41%, 42%, 43%, 44%, or 45% compared with a synthetic polymer host material that does not contain the one or more inorganic phosphor dopants. Photo-oxidation of a material can be detected using infrared spectroscopy, for example. In particular, peroxy-species and carbonyl groups formed by photo-oxidation often contain distinct absorption bands.

In certain examples of the method for improving color stability of a synthetic polymer, the visible light (104) emitted by the one or more inorganic phosphor dopants (102) produces a brighter appearance for the synthetic polymer composition. The brighter appearance is perceived by a viewer observing the synthetic polymer composition. Indeed, “brightness” as used herein is an attribute of visual perception in which a source appears to be radiating or reflecting light. Brightness is the perception elicited by the luminance of a visual target. In certain examples, the inorganic phosphor dopant (102) can emit blue visible light (104), which has a wavelength between 450 nm and 495 nm. The blue visible light (104) emitted from the synthetic polymer composition comprising the one or more inorganic phosphor dopants can visually offset yellow discoloration of the synthetic polymer host material (101). The before-mentioned effect is similar to that of broad visible emission, in which certain dopants in a material that emit broad light have the effect of making the overall material appear visually brighter.

In certain examples of the method for improving color stability of a synthetic polymer, the light emitted by the one or more inorganic phosphor dopants (102) in the synthetic polymer host material (101) is down-converted visible light (104). In certain examples of the above method, the one or more inorganic phosphor dopants (102) emit visible light (104) with a wavelength between about 200 and 700 nm. In other examples, the one or more inorganic phosphor dopants (102) emit visible light (104) with a wavelength between about 400 nm and 495 nm, about 620 nm and 700 nm, about 590 and 620 nm, about 570 nm and 590 nm, about 495 nm and 570 nm, about 390 and 450 nm, about 380 nm and 600 nm, about 350 nm and 460 nm, about 600 nm and 700 nm, about 450 and 600 nm, about 200 and 280 nm, about 450 nm and 495 nm, about 380 and 450 nm, about 200 nm and 270 nm, about 200 nm and 250 nm, about 225 nm and 250 nm, about 200 nm and 225 nm, about 200 nm and 275 nm, or about 225 nm and 275 nm. The specific wavelength or range of wavelengths can be selected based on the desired color of light to be emitted. For example, if it is desirable for the inorganic phosphor dopant (102) to emit blue light, then a phosphor that emits visible light (104) with a wavelength between about 400 nm and 495 nm will be selected. In certain other examples, if it is desirable for the inorganic phosphor dopant (102) to emit green light, then a phosphor that emits visible light (104) with a wavelength between about 495 and 570 nm will be selected. In other examples, if it is desirable for the inorganic phosphor dopant (102) to emit violet light, then a phosphor that emits visible light (104) with a wavelength between about 380 nm and 450 nm will be selected. In certain other examples, if it is desirable for the inorganic phosphor dopant (102) to emit yellow light, then a phosphor that emits visible light (104) with a wavelength between about 570 nm and 590 nm will be selected. In further examples, if it is desirable for the inorganic phosphor dopant (102) to emit orange light, then a phosphor that emits visible light (104) with a wavelength between about 590 nm and 620 nm will be selected. Furthermore, in other examples, if it is desirable for the inorganic phosphor dopant (102) to emit red light, then a phosphor that emits visible light (104) with a wavelength between about 620 nm and 700 nm will be selected.

In certain examples of the method for improving color stability of a synthetic polymer, the synthetic polymer host material (101) comprises two or more inorganic phosphor dopants (102), wherein the down-converted visible light (104) emitted by the two or more inorganic phosphor dopants (102) combines to yield white or off-white light. In certain examples of the method for improving color stability of a synthetic polymer, the synthetic polymer host material comprises three or more inorganic phosphor dopants (102), wherein the down-converted visible light (104) emitted by the three or more inorganic phosphor dopants (102) combines to yield white or off-white light. For example, an inorganic phosphor dopant (102) that emits blue visible light (104) having a wavelength between about 450 nm and 495 nm can be inserted into a synthetic polymer host material (101) with a second inorganic phosphor dopant (102) that emits yellow visible light (104) having a wavelength between about 570 nm and 590 nm. The combination of blue and yellow visible light (104) emitted by the first and second inorganic phosphor dopants (102) will yield white or off-white emission (white visible light (104)). In a similar manner, a first inorganic phosphor dopant (102) that emits blue visible light (104) having a wavelength between about 450 nm and 495 nm can be inserted into a synthetic polymer host material (101) with a second inorganic phosphor dopant (102) that emits green visible light (104) having a wavelength between about 495 nm and 570 nm, and a third inorganic phosphor dopant (102) that emits red visible light (104) having a wavelength between about 620 nm and 750 nm. The combination of blue, green, and red visible light (104) emitted by the first, second, and third inorganic phosphor dopants (102) will yield white or off-white emission (white visible light (104)).

In certain examples of the method for improving color stability of a synthetic polymer, the synthetic polymer host material (101) is a thermoplastic or thermoset. In certain examples, the synthetic polymer host material (101) is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine. In particular, fluorine is known to strongly resist photo-oxidation because of its high electronegativity and desire to accept an electron. As such, in certain examples, fluorinated synthetic polymers, such as tetrafluoroethylene or polyvinyl fluoride, are useful for the synthetic polymers in the methods described herein. Additionally, thermosetting polymers are generally known to have a higher degree of cross linking compared to other types of polymers, which makes them further resistant to photo-oxidation.

In certain examples of the method for improving color stability of a synthetic polymer, the inorganic phosphor dopant (102) is a metal oxide (106) or metal fluoride (109) comprising a rare earth ion (107) or transition metal ion. The rare earth ion (107) or transition metal ion is referred to as an “activator ion.” As used herein, the “activator ion” is the ion added as a dopant to the crystal structure. The activator ions are surrounded by host-crystal ions and form luminescing centers where the excitation-emission process of the phosphor occurs. The wavelength emitted by the activator ion is dependent on the ion itself, its electronic configuration, and on its surrounding crystal structure. In certain examples, the rare earth ion (107) is a lanthanide ion. In certain examples, the rare earth ion (107) is selected from the group consisting of Tm³⁺, Pr³⁺, Ho³⁺, Er³⁺, Sm³⁺, Nd³⁺, Yb³⁺, Eu³⁺, Eu²⁺, Gd³⁺, Ce³⁺, Ce²⁺, Tb³⁺, Tb⁴⁺, Dy³⁺, Yb³⁺, Y³⁺ and Lu³⁺, or a combination thereof. In certain examples, the inorganic phosphor dopant (102) is a metal oxide (106) or metal fluoride (109) comprising a rare earth ion (107) selected from the group consisting of Pr³⁺, Ce³⁺, Eu³⁺; Eu²⁺, Gd³⁺, Tb³⁺, and Dy³⁺, or a mixture thereof. In certain examples the inorganic phosphor dopant is a metal oxide (106) comprising a rare earth ion (107). In examples, the rare earth ion (107) is selected in combination with the metal oxide (106) to prepare an inorganic phosphor dopant (102), such as shown in FIG. 1a, that will emit light having a particular color and wavelength. For example, Eu³⁺ doped in Y₂O₃ is expected to emit red-orange visible light (104) having a wavelength of about 611 nm, while Eu³⁺ doped in InBO₃ is expected to emit yellow visible light (104) having a wavelength of about 588 nm. In another example, Eu²⁺ doped in BaMg₂Al₁₆O₂₇ can be selected, which is expected to emit blue visible light (104) having a wavelength of about 450 nm.

In certain examples of the method for improving color stability of a synthetic polymer, the inorganic phosphor dopant (102) is a metal fluoride (109), selected from the group consisting of Cs₂NaYF₆, NaCeF₄, NaYF₄, and NaGd₄, and which comprises a rare earth ion (107) or transition metal ion. Such metal fluoride hosts are often characterized as having a large bandgap, structural defects that are likely to act as electron traps, and anionic defects, which make them useful for inorganic phosphors.

In certain examples of the method for improving color stability of a synthetic polymer, the inorganic phosphor dopant (102) is a metal oxide (106), selected from the group consisting of silicates, phosphates, borates, oxides, oxynitrides, oxysulfides, and aluminates, or combinations thereof. In certain examples, the silicate is selected from the group consisting of melilite, cyclosilicate, silicate garnet, oxyorthosilicate, and orthosilicate. Nonlimiting examples of silicates include Sr₂MgSi₂O₇, Ca₂Al₂SiO₇, SrAl₂O₄, MgSiO₃, SrSiO₃, CdSiO₃, Ba₂SiO₄, BaMg₂Si₂O₇, Ca₂MgSi₂O₇, Sr_{0.5}Ca_{1.5}MgSi₂O₇, (Ca,Sr)₂MgSi₂O₇, Sr₃MgSi₂O₈, Sr₂MgSi₂O₇, Ca_{0.5}Sr_{1.5}Al₂SiO₇, Sr₃Al₁₀SiO₂₀, and Y₂SiO₅. Nonlimiting examples of borates include YBO₃, InBO₃, and CaAl₂B₂O₇. Nonlimiting examples of oxynitrides include MSi₂O₂N₂, wherein M is Ba, Sr, or Ca. Nonlimiting examples of phosphates include YPO₄ and Zn₃(PO₄)₂. Nonlimiting examples of oxides include CaO, SrO, BaO, Y₃Ga₅O₁₂, NaGdGeO₄, Cd₃Al₂Ge₃O₁₂, CaTiO₃, Ca_{0.8}Zn_{0.2}TiO₃, and Ca₂Zn₄Ti₁₅O₃₆. Nonlimiting examples of oxysulfides include Y₂O₂S, Gd₂O₂S, and Sr₅Al₂O₇S. Nonlimiting examples of aluminates include MgAl₂O₄, CaAl₂O₄, SrAl₂O₄, and Sr₄Al₁₄O₂₅.

In certain examples, the synthetic polymer host material (101) comprises two different inorganic phosphor dopants (102), wherein each inorganic phosphor dopant (102) is a metal oxide (106) or metal fluoride (109) comprising a rare earth ion (107), and wherein the combined emission of the two inorganic phosphor dopants (102) produces white or off-white light visible light (104). In certain examples, the synthetic polymer host material (101) comprises two different inorganic phosphor dopants (102) wherein said two different inorganic phosphor dopants (102) are metal oxides (106) comprising a rare earth ion (107). As one example, the synthetic polymer host material (101) can comprise a first inorganic phosphor dopant (102) of Y₂SiO₅:Ce(III), which emits blue visible light (104) having a wavelength of about 400 nm, and a second inorganic phosphor dopant (102) of InBO₃:Eu(III), which emits yellow visible light (104) having a wavelength of about 588 nm. Together, the combined visible light will yield white or off-white visible light (104).

In certain examples, the synthetic polymer host material (101) comprises three different inorganic phosphor dopants (102), wherein each inorganic phosphor dopant (102) is a metal oxide (106) or metal fluoride (109) comprising a rare earth ion (107), and wherein the combined emission of the three inorganic phosphor dopants (102) produces white or off-white visible light (104). For example, in certain examples, the synthetic polymer host material (101) can comprise a first inorganic phosphor dopant (102) of BaMg₂Al₁₆O₂₇:Eu(II), which emits blue visible light (104) having a wavelength of about 450 nm, a second inorganic phosphor dopant (102) of Y₂SiO₅:Tb(III), which emits green visible light (104) having a wavelength of about 545 nm, and a third inorganic phosphor dopant (102) of Y₂O₃:Eu(III), which emits red visible light (104) having a wavelength of about 611 nm. Together, the combined visible light will yield white or off-white visible light (104).

In certain examples of the method for improving color stability of a synthetic polymer composition, the synthetic polymer composition is a substrate or surface located in the interior of an airplane. In certain other examples, the synthetic polymer composition is a substrate or surface located in a hospital or other healthcare facility, school, gym, or automobile.

In certain examples of the method for improving color stability of a synthetic polymer composition, the exposing the synthetic polymer host material (101) comprising one or more inorganic phosphor dopants (102) to UV light (103) is for a time sufficient to charge the one or more inorganic phosphor dopants (102) in the synthetic polymer host material (101). In certain examples, the time sufficient to charge the one or more inorganic phosphor dopants (102) in the synthetic polymer host material (101) is for about five minutes, ten minutes, fifteen minutes, twenty minutes, thirty minutes, forty-five minutes, one hour, two hours, three hours, five hours, seven hours, ten hours, fifteen hours, twenty hours, or twenty-four hours.

The one or more inorganic phosphor dopants (102) absorb UV light (103) and emit the UV light (103) as down-converted visible light (104) for a time typically on the order of nanoseconds. Further, in examples, the phosphors absorb energy and do not release light immediately. Rather, in examples, the energy dissipates in picoseconds to the lowest excited state prior to emission. In certain examples, with the application of continuous illumination, for example, the one or more inorganic phosphor dopants (102) absorb UV light (103) and emit the UV light as down-converted visible light (104) continuously.

In certain other examples, persistent phosphors can be applied in the above method for improving color stability of a synthetic polymer composition. Persistent phosphors are different from ordinary conversion phosphors as they exhibit light emission that persists seconds to hours after the excitation has stopped. The reason for this delayed emission is their ability to store energy in the material, presumably at defects other than the luminescent “activator” ion. These defects are called traps because a charge carrier originating from the luminescent ion is locally trapped at the defect. When sufficient energy is provided to the trapped charge it will be released. After recombination at the luminescent ion, it will give rise to the delayed emission that is generally referred to as afterglow. The timespan of the afterglow can be tuned, as it depends on the so-called depth of the trap, which is typically probed by thermoluminescence. For example, it is generally understood that shallow traps are easily emptied, whereas deep traps are difficult to empty at room temperature; a portion of captured electrons remains stored there. If a trap is too deep, the captured electrons cannot escape, preventing persistent after-glow. Thermoluminescence can be used to evaluate the trap depth. Indeed, a thermoluminescence glow curve represents the intensity of emitted light versus temperature; each glow peak is associated with a recombination center and related to a specific trap. The glow curve can provide useful information for the material. Activation energy and escape frequency factor can be calculated from the glow curve, for example. Many methods can be used to calculate trap parameters based on the kinetics order of glow peaks, such as initial rise method and variable heating rates. Based on the glow curve, the luminescence efficiency of a material can be obtained.

The changes in the structure-luminescence properties of a material can be observed through modifications in its glow curve. A decrease in thermoluminescence intensity can sometimes be attributed to the suppression of traps, for example. In other examples, the luminescence efficiency of a material can increase upon the addition of impurities (such as another ion) to the phosphor. The presence of such impurities can modify trap distributions, as well as deepen trap sites caused by modifications in energy gaps in the phosphor. Thermoluminescence glow curves can be obtained using a thermoluminescence meter, such as a FJ-427 A TL meter.

In certain other examples, the electronic transitions of the phosphors can be characterized as “forbidden.” A forbidden transition is a spectral line associated with absorption or emission of photons by atomic nuclei or atoms that undergo a transition that is not allowed by a particular selection rule, but is allowed if the approximation associated with that rule is not made. For example, in a situation where, according to usual approximations (such as the electric dipole approximation for the interaction with light), the process cannot happen, but at a higher level of approximation (i.e. magnetic dipole) the process is allowed but at a slower rate. One example of such a forbidden transition is observed in phosphorescent glow-in-the-dark materials, which absorb light and form an excited state whose decay involves a spin flip, which is forbidden by electric dipole transitions. The result is emission of light slowly over minutes or hours. Indeed, “forbidden” transitions occur at much slower speeds than “allowed” transitions. “Allowed” transitions are those that: follow appropriate (1) spin and (2) Laporte (orbital) selection rules; exhibit a change in parity (symmetry) during the transition; emit a photon having energy that matches the gap between the ground and excited state; and which exhibit a change in dipole moment. Allowed spin selection rules state that there should be no change in the spin orientation (i.e. no spin inversion proceeds during an electronic transition). In accordance with the Laporte selection rules, in a centrosymmetric environment, transitions between like atomic orbitals, such as s-s, p-p, d-d, or f-f transitions are forbidden. Even though a transition may be forbidden, it is often coupled with vibrational factors, which reduce the molecular symmetry of the system, for example and make some previously forbidden transitions allowed by the reduction in symmetry. This often results in weakly allowed transitions, and causes the transition rate to decrease. A typical emission lifetime of a material undergoing a forbidden transition can be milliseconds or even seconds.

As discussed above, one or more inorganic phosphor dopants (102) can be used to tailor the emissivity to longer or shorter wavelengths and to also create white light in certain examples.

In certain examples of the method for improving color stability of a synthetic polymer composition, the synthetic polymer host material (101) is a thermoplastic material, wherein the thermoplastic material is polyvinyl fluoride; the synthetic polymer host material (101) comprises two inorganic phosphor dopants (102), wherein the first inorganic phosphor dopant (102) is Y₂SiO₅:Ce(III), which emits blue visible light (104) having a wavelength of about 400 nm, and the second inorganic phosphor dopant (102) is InBO₃:Eu(III), which emits yellow visible light (104) having a wavelength of about 588 nm. The phosphors in the thermoplastic host material are exposed to UV light (103) using a Xenon-ultraviolet wand for approximately ten minutes before they emit visible light (104), which is combined to produce white visible light (104).

### III. Synthetic Polymer Composition Having Improved Color Stability

In certain examples, the subject matter described herein is directed to a synthetic polymer composition having improved color stability, comprising:
a synthetic polymer host material (101) comprising one or more inorganic phosphor dopants (102), wherein the one or more inorganic phosphor dopants (102) in the synthetic polymer host material (101) emit down-converted visible light (104) upon exposure to UV light (103); and
wherein the synthetic polymer composition exhibits mechanical and flammability properties comparable to that of a synthetic polymer composition without the one or more inorganic phosphor dopants.

As used herein, when the synthetic polymer composition exhibits mechanical and flammability properties “comparable” to that of a synthetic polymer composition, the synthetic polymer composition comprising one or more inorganic phosphor dopants possesses mechanical and flammability properties suitable for the material's intended use. As used herein, mechanical properties of the synthetic polymer composition can refer to its impact durability, tensile strength, and chemical resistance, among other properties. In certain examples, the presence of the one or more inorganic phosphor dopants (102) may enhance the flammability performance of the synthetic polymer host material (101).

In certain examples of the synthetic polymer composition having improved color stability, the synthetic polymer host material (101) is a thermoplastic or thermoset. In certain examples, the synthetic polymer host material (101) is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine. In particular, fluorine is known to strongly resist photo-oxidation because of its high electronegativity and desire to accept an electron. As such, in certain examples, fluorinated synthetic polymers, such as tetrafluoroethylene or polyvinyl fluoride, are useful for the synthetic polymers in the methods described herein.

In certain examples of the synthetic polymer composition having improved color stability, the inorganic phosphor dopant (102) is a metal oxide (106) or metal fluoride (109) comprising a rare earth ion (107) or transition metal ion. In certain examples, the rare earth ion (107) is a lanthanide ion. In certain examples, the rare earth ion (107) is selected from the group consisting of Tm³⁺, Pr³⁺, Ho³⁺, Er³⁺, Sm³⁺, Nd³⁺, Yb³⁺, Eu³⁺; Eu²⁺, Gd³⁺, Ce³⁺, Ce²⁺, Tb³⁺, Tb⁴⁺, Dy³⁺, Yb³⁺, Y³⁺ and Lu³⁺, or a combination thereof. In certain examples, the inorganic phosphor dopant is a metal oxide (106) or metal fluoride (109) comprising a rare earth ion (107) selected from the group consisting of Pr³⁺, Ce³⁺, Eu³⁺, Eu³⁺, Gd³⁺, Tb³⁺, and Dy³⁺, or a mixture thereof. In certain examples, the inorganic phosphor dopant is a metal oxide (106). The rare earth ion (107) is selected in combination with the metal oxide (106) to prepare a phosphor that will emit visible light (104) having a particular color and wavelength. For example, Eu³⁺ doped in Y₂O₃ is expected to emit red-orange visible light (104) having a wavelength of about 611 nm, while Eu³⁺ doped in InBO₃ is expected to emit yellow visible light (104) having a wavelength of about 588 nm. In another example, Eu²⁺ doped in BaMg₂Al₁₆O₂₇ can be selected, which is expected to emit blue visible light (104) having a wavelength of about 450 nm.

In certain examples of the synthetic polymer composition having improved color stability, wherein the inorganic phosphor dopant (102) is a metal oxide (106), the metal oxide (106) is selected from the group consisting of silicates, phosphates, borates, oxides, oxynitrides, oxysulfides, and aluminates, or combinations thereof. Such metal oxides (106) are ceramic materials and thus exhibit several advantages, including chemical, thermal, and photochemical stability as a result of their robust lattice structure. In certain examples, the silicate is selected from the group consisting of melilite, cyclosilicate, silicate garnet, oxyorthosilicate, and orthosilicate. Nonlimiting examples of silicates include Sr₂MgSi₂O₇, Ca₂Al₂SiO₇, SrAl₂O₄, MgSiO₃, SrSiO₃, CdSiO₃, Ba₂SiO₄, BaMg₂Si₂O₇, Ca₂MgSi₂O₇, Sro₅Ca_{0.5}MgSi₂O₇, (Ca,Sr)₂MgSi₂O₇, Sr₃MgSi₂O₈, Sr₂MgSi₂O₇, Ca_{0.5}Sr_{1.5}Al₂SiO₇, Sr₃Al₁₀SiO₂₀, and Y₂SiO₅. Nonlimiting examples of borates include YBO₃, InBO₃, and CaAl₂B₂O₇. Nonlimiting examples of oxynitrides include MSi₂O₂N₂, wherein M is Ba, Sr, or Ca. Nonlimiting examples of phosphates include YPO₄ and Zn₃(PO₄)₂. Nonlimiting examples of oxides include CaO, Sr₀, BaO, Y₃Ga₅O₁₂, NaGdGeO₄, Cd₃Al₂Ge₃O₁₂, CaTiO₃, Ca_{0.8}Zn_{0.2}TiO₃, and Ca₂Zn₄Ti₁₅O₃₆. Nonlimiting examples of oxysulfides include Y₂O₂S, Gd₂O₂S, and Sr₅Al₂O₇S. Nonlimiting examples of aluminates include MgAl₂O₄, CaAl₂O₄, SrAl₂O₄, and Sr₄Al₁₄O₂₅.

In certain examples of the synthetic polymer composition having improved color stability, the inorganic phosphor dopant (102) is a metal fluoride (109), selected from the group consisting of Cs₂NaYF₆, NaCeF₄, NaYF₄, and NaGd₄, and which comprises a rare earth ion (107) or transition metal ion. Such metal fluoride hosts are often characterized as having a large bandgap, structural defects that are likely to act as electron traps, and anionic defects, which make them useful for inorganic phosphors.

In certain examples of the synthetic polymer composition having improved color stability, the synthetic polymer material comprises two different inorganic phosphor dopants (102), wherein each inorganic phosphor dopant is a metal oxide (106) or metal fluoride (109) comprising a rare earth ion (107), and wherein the combined emission of the two inorganic phosphor dopants (102) produces white or off-white visible light (104).

In certain examples, the synthetic polymer material comprises two different inorganic phosphor dopants (102), wherein each inorganic phosphor dopant is a metal oxide (106) comprising a rare earth ion (107), and wherein the combined emission of the two inorganic phosphor dopants (102) produces white or off-white visible light (104). For example, in certain examples, the synthetic polymer host material (101) can comprise a first inorganic phosphor dopant of Y₂SiO₅:Ce(III), which emits blue visible light (104) having a wavelength of about 400 nm, and a second inorganic phosphor dopant of InBO₃:Eu(III), which emits yellow visible light (104) having a wavelength of about 588 nm. Together, the combined visible light will yield white or off-white visible light (104).

In certain examples, the synthetic polymer material comprises three different inorganic phosphor dopants (102), wherein each inorganic phosphor dopant is a metal oxide (106) or metal fluoride (109) comprising a rare earth ion (107), and wherein the combined emission of the three inorganic phosphor dopants (102) produces white or off-white visible light (104). In certain examples, the synthetic polymer material comprises three different inorganic phosphor dopants (102), wherein each inorganic phosphor dopant is a metal oxide (106) comprising a rare earth ion (107), and wherein the combined emission of the three inorganic phosphor dopants (102) produces white or off-white visible light (104). For example, the synthetic polymer host material (101) can comprise a first inorganic phosphor dopant of BaMg₂Al₁₆O₂₇:Eu(II), which emits blue visible light (104) having a wavelength of about 450 nm, a second inorganic phosphor dopant of Y₂SiO₅:Tb(III), which emits green visible light (104) having a wavelength of about 545 nm, and a third inorganic phosphor dopant of Y₂O₃:Eu(III), which emits red visible light (104) having a wavelength of about 611 nm. Together, the combined visible light will yield white or off-white visible light (104).

In certain examples of the synthetic polymer composition having improved color stability, the synthetic polymer composition comprises a substrate or surface located in an interior of an airplane. Other non-limiting examples of where the substrate or surface can be located include gyms, school, healthcare facilities, or automobiles.

In certain examples of the synthetic polymer composition, the one or more inorganic phosphor dopants (102) in the synthetic polymer host material (101) emit down-converted visible light (104) upon exposure to UV light (103). In certain other examples of the synthetic polymer composition, the one or more inorganic phosphor dopants (102) emit light with a wavelength between about 200 and 700 nm. In other examples, the one or more inorganic phosphor dopants (102) emit visible light (104) with a wavelength between about 400 nm and 500 nm, about 620 nm and 700 nm, about 590 and 620 nm, about 570 nm and 590 nm, about 495 nm and 570 nm, about 390 and 450 nm, about 380 nm and 600 nm, about 350 nm and 460 nm, about 600 nm and 700 nm, about 450 and 600 nm, about 200 and 280 nm, about 450 nm and 495 nm, 200 nm and 270 nm, about 200 nm and 250 nm, about 225 nm and 250 nm, about 200 nm and 225 nm, about 200 nm and 275 nm, or about 225 nm and 275 nm.

In certain examples of the synthetic polymer composition, the synthetic polymer host material (101) is a thermoplastic material, wherein the thermoplastic material is polyvinyl fluoride; the host material comprises two inorganic phosphor dopants (102), wherein the first inorganic phosphor dopant is Y₂SiO₅:Ce(III), which emits blue visible light (104) having a wavelength of about 400 nm, and the second inorganic phosphor dopant is InBO₃:Eu(III), which emits yellow visible light (104) having a wavelength of about 588 nm.

### IV. Methods for Preparing a Synthetic Polymer Composition Having Improved Color Stability

In certain examples, the subject matter described herein is directed to a method for preparing a synthetic polymer composition having improved color stability, comprising: contacting a synthetic polymer host material (101) with one or more inorganic phosphor dopants (102) to prepare an inorganic phosphor-doped synthetic polymer material, wherein the one or more inorganic phosphor dopants (102) in the inorganic phosphor-doped synthetic polymer material are capable of absorbing UV light (103) and then emitting the UV light as down-converted visible light (104).

In certain examples of the method for preparing a synthetic polymer composition having improved color stability, the one or more inorganic phosphor dopants (102) are capable of emitting UV light as down-converted visible light (104). In certain other examples of the method for preparing a synthetic polymer composition having improved color stability, the one or more inorganic phosphor dopants (102) emit light with a wavelength between about 200 and 700 nm. In other examples, the one or more inorganic phosphor dopants (102) emit visible light (104) with a wavelength between about 400 nm and 500 nm, about 620 nm and 700 nm, about 590 and 620 nm, about 570 nm and 590 nm, about 495 nm and 570 nm, about 390 and 450 nm, about 380 nm and 600 nm, about 350 nm and 460 nm, about 600 nm and 700 nm, about 450 and 600 nm, about 200 and 280 nm, about 450 nm and 495 nm, 200 nm and 270 nm, about 200 nm and 250 nm, about 225 nm and 250 nm, about 200 nm and 225 nm, about 200 nm and 275 nm, or about 225 nm and 275 nm.

In certain examples of the method for preparing a synthetic polymer composition having improved color stability, the synthetic polymer host material (101) is a thermoplastic or thermoset. In certain examples, the synthetic polymer host material (101) is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.

In certain examples of the method for preparing a synthetic polymer composition having improved color stability, the inorganic phosphor dopant is a metal oxide (106) or metal fluoride (109) comprising a rare earth ion (107) or transition metal ion. In certain examples, the rare earth ion (107) is a lanthanide ion. In certain examples, the rare earth ion (107) is selected from the group consisting of Tm³⁺, Pr³⁺, Ho³⁺, Er³⁺, Sm³⁺, Nd³⁺, Yb³⁺, Eu³⁺; Eu²⁺, Gd³⁺, Ce³⁺, Ce²⁺, Tb³⁺, Tb⁴⁺, Dy³⁺, Yb³⁺, and Lu³⁺, or a combination thereof.

In certain examples, the inorganic phosphor dopant is a metal oxide (106) comprising a rare earth ion (107) selected from the group consisting of Pr³⁺, Ce³⁺, Eu³⁺, Eu³⁺, Gd³⁺, Tb³⁺, and Dy³⁺, or a mixture thereof.

In certain examples of the method for preparing a synthetic polymer composition having improved color stability, the inorganic phosphor dopant (102) is a metal oxide (106), wherein the metal oxide (106) is selected from the group consisting of silicates, phosphates, borates, oxides, oxynitrides, oxy sulfides, and aluminates, or combinations thereof. In certain examples, the silicate is selected from the group consisting of melilite, cyclosilicate, silicate garnet, oxyorthosilicate, and orthosilicate. Nonlimiting examples of silicates include Sr₂MgSi₂O₇, Ca₂Al₂SiO₇, SrAl₂O₄, MgSiO₃, SrSiO₃, CdSiO₃, Ba₂SiO₄, BaMg₂Si₂O₇, Ca₂MgSi₂O₇, Sr_{0.5}Ca_{1.5}MgSi₂O₇, (Ca,Sr)₂MgSi₂O₇, Sr₃MgSi₂O₈, Sr₂MgSi₂O₇, Ca_{0.5}Sr_{1.5}Al₂SiO₇, Sr₃Al₁₀SiO₂₀, and Y₂SiO₅. Nonlimiting examples of borates include YBO₃, InBO₃, and CaAl₂B₂O₇. Nonlimiting examples of oxynitrides include MSi₂O₂N₂, wherein M is Ba, Sr, or Ca. Nonlimiting examples of phosphates include YPO₄ and Zn₃(PO₄)₂. Nonlimiting examples of oxides include CaO, SrO, BaO, Y₃Ga₅O₁₂, NaGdGeO₄, Cd₃Al₂Ge₃O₁₂, CaTiO₃, Ca_{0.8}Zn_{0.2}TiO₃, and Ca₂Zn₄Ti₁₅O₃₆. Nonlimiting examples of oxysulfides include Y₂O₂S, Gd₂O₂S, and Sr₅Al₂O₇S. Nonlimiting examples of aluminates include MgAl₂O₄, CaAl₂O₄, SrAl₂O₄, and Sr₄Al₁₄O₂₅.

In certain examples of the method for preparing a synthetic polymer composition having improved color stability, the synthetic polymer material comprises two different inorganic phosphor dopants (102), wherein each inorganic phosphor dopant is a metal oxide (106) or metal fluoride (109) comprising a rare earth ion (107), and wherein the combined emission of the two inorganic phosphor dopants (102) produces white or off-white visible light (104). In certain examples, the synthetic polymer material comprises two different inorganic phosphor dopants (102), wherein each inorganic phosphor dopant is a metal oxide (106) comprising a rare earth ion (107), and wherein the combined emission of the two inorganic phosphor dopants (102) produces white or off-white visible light (104). For example, in certain examples, the synthetic polymer host material (101) can comprise a first inorganic phosphor dopant of Y₂SiO₅:Ce(III), which emits blue visible light (104) having a wavelength of about 400 nm, and a second inorganic phosphor dopant of InBO₃:Eu(III), which emits yellow visible light (104) having a wavelength of about 588 nm. Together, the combined visible light will yield white or off-white visible light (104).

In certain examples of the method for preparing a synthetic polymer composition having improved color stability, the inorganic phosphor dopant (102) is a metal fluoride (109), selected from the group consisting of Cs₂NaYF₆, NaCeF₄, NaYF₄, and NaGd₄, and which comprises a rare earth ion (107) or transition metal ion. Such metal fluoride hosts are often characterized as having a large bandgap, structural defects that are likely to act as electron traps, and anionic defects, which make them useful for inorganic phosphors.

In certain examples of the method for preparing a synthetic polymer composition having improved color stability, the synthetic polymer material comprises three different inorganic phosphor dopants (102), wherein each inorganic phosphor dopant is a metal oxide (106) or metal fluoride (109) comprising a rare earth ion (107), and wherein the combined emission of the three inorganic phosphor dopants (102) produces white or off-white visible light (104). In certain examples, the synthetic polymer material comprises three different inorganic phosphor dopants (102), wherein each inorganic phosphor dopant is a metal oxide (106) comprising a rare earth ion (107), and wherein the combined emission of the three inorganic phosphor dopants (102) produces white or off-white visible light (104). For example, in certain examples, the synthetic polymer host material (101) can comprise a first inorganic phosphor dopant (102) of BaMg₂Al₁₆O₂₇:Eu(II), which emits blue visible light (104) having a wavelength of about 450 nm, a second inorganic phosphor dopant (102) of Y₂SiO₅:Tb(III), which emits green visible light (104) having a wavelength of about 545 nm, and a third inorganic phosphor dopant (102) of Y₂O₃:Eu(III), which emits red visible light (104) having a wavelength of about 611 nm. Together, the combined visible light will yield white or off-white visible light (104).

In certain examples of the method for preparing a synthetic polymer composition having improved color stability, the synthetic polymer host material (101) is a thermoplastic material, wherein the thermoplastic is material is polyvinyl fluoride; the host material comprises two inorganic phosphor dopants (102), wherein the first inorganic phosphor dopant (102) is Y₂SiO₅:Ce(III), which emits blue visible light (104) having a wavelength of about 400 nm, and the second inorganic phosphor dopant (102) is InBO₃:Eu(III), which emits yellow visible light (104) having a wavelength of about 588 nm.

In examples, the synthetic polymer composition prepared exhibits mechanical and flammability properties comparable to that of a synthetic polymer composition without the one or more inorganic phosphor dopants. ASTM E1354 (ASTM E-1354), for example, is a fire-test-response standard that measures the response of materials to a controlled level of radiant heat and can be used to assess a material's flammability properties. Other methods for analyzing a material's flammability properties include ASTM D7309-21b and ASTM E2058-19. A material's mechanical properties can be assessed using a universal testing machine to measure, for example, tensile strength or compressive strength. Additionally, a hydraulic fatigue tester can be used to measure a material's fatigue.

In certain examples of the method for preparing a synthetic polymer composition having improved color stability, the contacting the synthetic polymer host material (101) with one or more inorganic phosphor dopants (102) to prepare an inorganic phosphor-doped synthetic polymer material can proceed for a time sufficient to incorporate the one or more inorganic phosphor dopants (102) into the synthetic polymer host material (101).

Methods for preparing solid state phosphors are known in the art. See, for example, Broxtermann et al. ECS Journal of Solid State Science and Technology, 6 (4) R47-R52 (2017); and Poelman et al. Journal of Applied Physics 128, 240903 (2020). In examples, metal oxide (or metal fluoride) host materials and rare earth oxides are weighed out such that an amount of rare earth ion is substituted or doped into the metal oxide (or metal fluoride) lattice. The amount of ion to be added can be determined by calculating the proposed stoichiometry of the material and then weighing out appropriate amounts of starting materials using dimensional analysis. The metal oxide powders are intimately ground up using a mortar and pestle in order to maximize contact between the particles in the mixture. Once placed in a suitable crucible (often alumina), the mixture is heated in a tube or muffle furnace up to a temperature, sufficient to induce a solid state reaction, but below the melting temperature of the final compound. From a temperature around 200-300° C. below this melting temperature, there is a strong increase in the grain size of the final compound. This heating process is called sintering. Sintering typically leads to a very dense and strongly agglomerated material, which is not directly applicable as a phosphor. Therefore, post-synthesis grinding—manually or using a ball mill—is often required.

Ball milling is a mechanical method whereby particles are reduced in size by mechanical impact and friction. Typically, powders are placed in a grinding jar, together with a number of hard grinding balls (often Al₂O₃ or ZrO₂) and a solvent so that a slurry is obtained. The grinding jar is then moved in order to achieve maximum friction. Similar to the case of manual grinding using a mortar and pestle, the effect of the process is highly dependent on the size and hardness of the starting material.

For the solid-state synthesis described above, the atmosphere used for heating can vary depending on the host material. In the case of oxides, air can usually be applied. However, some dopants, notably europium, can be oxidized in an oxygen lattice while heating in oxygen, leading to the formation of fully oxidized Eu³⁺ dopants. If Eu²⁺ is the preferred valence state of this dopant, then it can be necessary to perform an additional thermal treatment in a reducing atmosphere, such as helium or argon.

Other methods for preparing inorganic phosphor dopants (102) include sol-gel synthesis, colloidal synthesis, and co-precipitation. In a sol-gel process, for example the powders are weighed out and dissolved in concentrated acid, like HNO₃ (such as 70% w/w), and then diluted with deionized water. This solution can then be cooled to room-temperature and added dropwise to a cold-saturated aqueous solution of another acid, such as oxalic acid. A solid material is then precipitated and washed with deionized water and other polar solvents (such as acetone, acetonitrile, dimethylformamide (DMF), dimethylsulfoxide (DMSO), isopropanol, or methanol). The solid material will then undergo calcination at a temperature of about 1000° C. to 1200° C. for several hours, followed by intermittent grinding and sintering. In certain examples, after weighing and mixing, the metal oxide host powder and rare earth oxide powder are directly placed in a furnace at 1000-1100° C. for 2-48 hours.

The prepared solid state phosphor dopant materials are then inserted into the synthetic polymer substrate host material. The synthetic polymer substrate host material can be purchased from a commercial supplier, such as Dupont or Sigma. The solid state phosphor material is a powder, and can be incorporated into the synthetic polymer substrate host material by melting the polymer substrate and then mixing in the solid state phosphor material. If two or more inorganic phosphor dopants (102) are being incorporated into the synthetic polymer substrate host material, then the two or more inorganic phosphor dopant powders can be mixed first and then dispersed throughout the synthetic polymer substrate host material. The mixing of the powders throughout the substrate host material can be facilitated, for example, by further heating the material, and/or by using a mixing paddle.

An amount of solid state phosphor dopant sufficient to maintain the color stability of the synthetic polymer host can be incorporated into the synthetic polymer host material (101). After the solid state phosphor dopant is incorporated into the synthetic polymer host material (101), the inorganic phosphor-doped synthetic polymer host material (101) is cured. Curing can proceed, for example, at room temperature in air. Curing allows the inorganic phosphor-doped synthetic polymer host material (101) to harden with the inorganic phosphor dopant homogeneously dispersed throughout the substrate material.

Further, the disclosure comprises examples according to the following clauses:
Clause 1. A method for improving color stability of a synthetic polymer composition, comprising:
exposing a synthetic polymer host material comprising one or more inorganic phosphor dopants to UV light;
wherein the one or more inorganic phosphor dopants in the synthetic polymer host material absorb the UV light and then emit the UV light as down-converted visible light.
   Clause 2. The method of clause 1, wherein absorption of the UV light by the one or more inorganic phosphor dopants reduces photo-oxidation of the synthetic polymer host material.
   Clause 3. The method of clause 1 or 2, wherein the visible light emitted by the one or more inorganic phosphor dopants produces a brighter appearance for the synthetic polymer composition.
   Clause 4. The method of any of clauses 1-3, wherein the synthetic polymer host material comprises two or more inorganic phosphor dopants, wherein the down-converted visible light emitted by the two or more inorganic phosphor dopants combines to yield white or off-white light.
   Clause 5. The method of any of clauses 1-4, wherein the synthetic polymer host material comprises three or more inorganic phosphor dopants, wherein the down-converted visible light emitted by the three or more inorganic phosphor dopants combines to yield white or off-white light.
   Clause 6. The method of any of clauses 1-5, wherein the UV light absorbed by the one or more inorganic phosphor dopants has a wavelength between about 160 nm and 380 nm.
   Clause 7. The method of clause 6, wherein the UV light absorbed by the one or more inorganic phosphor dopants has a wavelength of about 222 nm, 254 nm, or 275 nm.
   Clause 8. The method of any of clauses 1-7, wherein the synthetic polymer host material is a thermoplastic or thermoset.
   Clause 9. The method of clause 8, wherein the synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.
   Clause 10. The method of any of clauses 1-9, wherein the one or more inorganic phosphor dopants are a metal oxide or metal fluoride comprising a rare earth ion selected from the group consisting of Pr³⁺, Ce³⁺, Eu³⁺, Eu³⁺, Gd³⁺, Tb³⁺, and Dy³⁺, or a combination thereof.
   Clause 11. The method of clause 10, wherein the metal oxide is selected from the group consisting of silicates, phosphates, borates, oxides, oxynitrides, oxysulfides, and aluminates, or combinations thereof.
   Clause 12. A synthetic polymer composition comprising:
a synthetic polymer host material comprising one or more inorganic phosphor dopants, wherein the one or more inorganic phosphor dopants in the synthetic polymer host material emit down-converted visible light upon exposure to UV light; and
wherein the synthetic polymer composition exhibits mechanical and flammability properties comparable to that of a synthetic polymer composition without the one or more inorganic phosphor dopants.
   Clause 13. The synthetic polymer composition of clause 12, wherein the UV light has a wavelength between about 160 nm and 380 nm.
   Clause 14: The synthetic polymer composition of clause 13, wherein the UV light has a wavelength of about 222 nm, 254 nm, or 275 nm.
   Clause 15. The synthetic polymer composition of any of clauses 12-14, wherein the synthetic polymer host material is a thermoplastic or thermoset.
   Clause 16. The synthetic polymer composition of clause 15, wherein the synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.
   Clause 17. The synthetic polymer composition of any of clauses 12-16, wherein the one or more inorganic phosphor dopants are a metal oxide or metal fluoride comprising a rare earth ion selected from the group consisting of Pr³⁺, Ce³⁺, Eu³⁺, Eu³⁺, Gd³⁺, Tb³⁺, and Dy³⁺, or a combination thereof.
   Clause 18. The synthetic polymer composition of clause 17, wherein the metal oxide is selected from the group consisting of silicates, phosphates, borates, oxides, oxynitrides, oxysulfides, and aluminates, or combinations thereof.
   Clause 19. The synthetic polymer of composition of any of clauses 12-18, wherein the polymer composition has improved color stability compared with a coating lacking one or more inorganic phosphor dopants that underwent UV exposure.
   Clause 20. A method for preparing a synthetic polymer composition comprising:
contacting a synthetic polymer host material with one or more inorganic phosphor dopants to prepare an inorganic phosphor-doped synthetic polymer material, wherein the one or more inorganic phosphor dopants in the inorganic phosphor-doped synthetic polymer material are capable of absorbing UV light and then emitting the UV light as down-converted visible light.
   Clause 21. The method of clause 20, wherein the UV light absorbed by the one or more inorganic phosphor dopants has a wavelength between about 160 nm and 380 nm.
   Clause 22. The method of clause 21, wherein the UV light absorbed by the one or more inorganic phosphor dopants has a wavelength of about 222 nm, 254 nm, or 275 nm.
   Clause 23. The method of any of clauses 20-22, wherein the synthetic polymer host material is a thermoplastic or thermoset.
   Clause 24. The method of clause 23, wherein the synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.
   Clause 25. The method of any of clauses 20-24, wherein the one or more inorganic phosphor dopants are a metal oxide or metal fluoride comprising a rare earth ion selected from the group consisting of Pr³⁺, Ce³⁺, Eu³⁺, Eu³⁺, Gd³⁺, Tb³⁺, and Dy³⁺, or a combination thereof.
   Clause 26. The method of clause 25, wherein the metal oxide is selected from the group consisting of silicates, phosphates, borates, oxides, oxynitrides, oxysulfides, and aluminates, or combinations thereof.
   Clause 27. The method of any of clauses 20-26, wherein the synthetic polymer composition prepared exhibits mechanical and flammability properties comparable to that of a synthetic polymer composition without the one or more inorganic phosphor dopants.
   Clause 28. The method of any of clauses 20-27, wherein the polymer composition has improved color stability compared with a coating lacking one or more inorganic phosphor dopants that underwent UV exposure.

The following examples are offered by way of illustration and not by way of limitation.

### Examples

Preparation of Synthetic Polymer Material Having Improved Color Stability

Step 1. Preparation of Y₂₋ₓSiO_{5:x}Ce Phosphor Powder

Analytical Y(NO₃)₃·6H₂O, Na₂SiO₃·9H₂O, Ce(NO₃)₃, and NaOH are purchased from Sigma Aldrich. First, Y(NO₃)₃·6H₂O, Na₂SiO₃·9H₂O, Ce(NO₃)₃, and NaOH are added to a 100 mL glass beaker in an amount such that the final product will yield a 0.75-2% substitution by cerium on the Y site in the Y₂SiO₅ lattice. After being agitated for 30 minutes, the solution is poured into a 70 mL hydrothermal autoclave. The autoclave is sealed and placed in a microwave digestion system. During the reaction process, the autoclave temperature is maintained at 200° C. After 20 minutes, the autoclave is removed from the microwave hydrothermal apparatus and cooled naturally to room temperature. Then, the precipitates are filtered, washed with deionized water and isopropyl alcohol, and dried at 80° C. for one hour. Following this, the inorganic phosphor dopants (102) Y₂₋ₓSiO_{5:x}Ce powders are heated at 700° C. and 900° C., respectively.

The prepared Y₂₋ₓSiO_{5:x} Ce inorganic phosphor dopant (102) is analyzed by powder X-ray diffraction. The crystal structure is solved using FullProf to verify the Ce/Y site mixing in the Y₂₋ₓ,SiO_{5:x}Ce crystal structure.

Step 2: Preparation of In₁₋ₓB_{3:x}Eu Phosphor Powder

Indium(III) nitrate, 99.9% (In(NO₃)₃), tri-n-butyl borate, 98% (C₁₂H₂₇BO₃), citric acid (C₆H₈O₇), and europium nitrate (Eu(N₃O)₉·5H₂O) are purchased from Sigma Aldrich. First, stoichiometric amounts of indium nitrate and tri-n-butyl borate are dissolved in distilled water. Europium nitrate is added to the solution in an amount such that the final product will yield a 0.75-2% substitution by europium on the In sites in the InBO₃ lattice. A sufficient amount of citric acid is then added to the solution as a chelating agent. A citric-acid-to-total-metal-ion molar ratio of 1:1 is used. The powder is dried in an oven at 120° C. for 10 hr. Following this, the powders undergo calcination at 700° C. for 3 hr. in air.

The prepared In₁₋ₓBO_{3:x} Eu inorganic phosphor dopant (102) is analyzed by powder X-ray diffraction. The crystal structure is solved using FullProf to verify the In/Eu site mixing in the InBO₃ crystal structure.

Step 3: Preparation of Y₂₋ₓSiO_{5:x}Ce and In₁₋ₓBO_{3:x}Eu-doped Polyvinyl Fluoride

Polyvinyl fluoride (Dupont) is heated under an Argon atmosphere to about 180° C., allowing the material to melt. The inorganic phosphor dopants (102), Y₂₋ₓSiO_{5:x}Ce and In₁₋ₓ BO_{3:x}Eu phosphor powders prepared in Steps 1 and 2 are mixed together and ground using an agate mortar and pestle. The mixed phosphor powder is then thoroughly mixed with the melted polyvinyl fluoride, such that the Y₂₋ₓSiO_{5:x}Ce and In₁₋ₓBO_{3:x} Eu are uniformly dispersed throughout the polyvinyl fluoride host material. The doped polyvinyl fluoride is then allowed to cure, forming a solidified Y₂₋ₓSiO_{5:x}Ce and In₁₋ₓBO_{3:x}Eu-doped polyvinyl fluoride substrate material.

In certain examples, the Y₂₋ₓSiO_{5:x}Ce and In₁₋ₓBO_{3:x}Eu-doped polyvinyl fluoride substrate material can be shaped while it cures, using, for example, a mold. The mold can assist with configuring the Y₂₋ₓSiO_{5:x}Ce and In₁₋ₓBO_{3:x}Eu-doped polyvinyl fluoride substrate material into a usable product, such as a cabinet, countertop, wall covering, or cover for a variety of household, healthcare, automobile, or aeronautic products. Additionally, after the solidified Y₂₋ₓSiO_{5:x}Ce and In₁₋ₓBO_{3:x}Eu-doped polyvinyl fluoride substrate material is prepared, the material can be easily shaped and modified, for example, using a saw, sandpaper, or a suitable mold.

The Color Stability of Y₂₋ₓSiO_{5:x}Ce and In₁₋ₓBO_{3:x}Eu-doped Polyvinyl Fluoride

The Y₂₋ₓSiO_{5:x}Ce and In₁₋ₓBO_{3:x}Eu-doped polyvinyl fluoride material prepared in Step 3 is exposed to a UV light (103) having a wavelength between about 160 nm and 380 nm. This is the radiant excitation energy for the Y₂₋ₓSiO_{5:x}Ce and In₁₋ₓBO_{3:x}Eu phosphors in the polyvinyl fluoride host substrate material. The substrate material is exposed to the UV lamp for approximately two to ten minutes, allowing the Y₂₋ₓSiO_{5:x}Ce and In₁₋ₓBO_{3:x} Eu phosphors to charge. The UV lamp is then turned off. The Y₂₋ₓSiO_{5:x}Ce and In₁₋ₓBO_{3:x}Eu phosphors in the polyvinyl fluoride host material then emit visible light (104) anywhere from about three nanoseconds to about fifteen minutes. The Y₂₋ₓSiO_{5:x}Ce phosphors emit blue light, having a wavelength of about 400 nm, and the In₁₋ₓBO_{3:x}Eu phosphors emit yellow visible light (104), having a wavelength of about 588 nm. The combined visible light from the phosphors generates white visible light (104), producing a brighter appearance for the polyvinyl material.

In another example, the UV light (103) can be a pulsed Xenon-ultraviolet device having a wavelength of about 222 nm, 254 nm, or 275 nm, and is used as the excitation source to excite the inorganic phosphor dopants (102), (i.e., Y₂₋ₓ,SiO_{5:x}Ce and In₁₋ₓBO_{3:x}Eu phosphors) in the polyvinyl fluoride host substrate material.

### Comparative Example: Flammability

ASTM E1354 (ASTM E-1354) is a fire-test-response standard that measures the response of materials to a controlled level of radiant heat. The test method is commonly used to test new products that are still in development, to prove code compliance for products entering the market, and for quality control purposes. ASTM E1354 utilizes a cone calorimeter and oxygen consumption calorimetry to determine the amount of heat released from a burning product. The rate of heat release (RHR) and the amount of heat released by a product are direct contributors to the severity of a fire, the spread of flames, and fire growth.

ASTM E1354 testing is conducted using a cone calorimeter. The primary components of a cone calorimeter are a conical-shaped furnace for generating radiant heat, a spark ignitor for lighting the test specimen, a load cell for measuring mass loss, and an exhaust system where smoke measurements and gas samples are taken. The gas that is sampled is passed through an oxygen analyzer to determine heat release.

In this example, cone calorimetry testing is conducted on polyvinyl fluoride host material and compared with that of Y₂₋ₓSiO_{5:x}Ce and In₁₋ₓBO_{3:x}Eu-doped polyvinyl fluoride material using ASTM E1354. Briefly, the test specimen is placed on top of the load cell and underneath the conical-shaped furnace. A spark ignitor is moved overtop the sample surface until sustained burning is achieved across the entire sample surface. The test can also be conducted without the use of the spark ignitor. The products of combustion are pulled through the exhaust system where a laser is passed through the duct to measure smoke and gas is sampled and sent to the oxygen analyzer. The test is continued until two minutes after one of the following: the last sign of flaming, the mass loss rate drops below 150 g/m², the specimen mass has been completely consumed, the oxygen concentration returns to pretest values, or 60 minutes have elapsed.

The ASTM E1354 report obtained from the above experimental procedure indicates that both the polyvinyl fluoride host material and the Y₂₋ₓSiO_{5:x}Ce and In₁₋ₓBO_{3:x}Eu-doped polyvinyl fluoride material exhibit comparable properties, including time to ignition, time of flame out, peak rate of heat release, time to peak rate of heat release, average rate of heat release, total heat released, average effective heat of combustion, average smoke extinction area, and time to peak smoke extinction area.

### Supplementary Example: Blending Phosphors with Polyacrylate

Polyacrylate is purchased from Alfa. The Y₂₋ₓSiO_{5:x}Ce and In₁₋ₓBO_{3:x}Eu phosphor powders prepared in steps 1 and 2 above are ground together and mixed in an agate mortar and pestle. The polyacrylate is heated to about 125° C., allowing the material to melt slightly. The phosphor powders are added to the melted polyacrylate and mixed for approximately ten minutes with a mixing paddle, allowing the powders to be evenly dispersed throughout the polyacrylate host material. The material is then allowed to cure in air.

The Color Stability of Y₂₋ₓSiO_{5:x}Ce and In₁₋ₓBO_{3:x}Eu-doped Polyacrylate

The Y₂₋ₓSiO_{5:x}Ce and In₁₋ₓBO_{3:x}Eu-doped polyacrylate material prepared above is exposed to a UV light (103) having a wavelength between about 160 nm and 380 nm. This is the radiant excitation energy for the Y₂₋ₓSiO_{5:x}Ce and In₁₋ₓBO_{3:x}Eu phosphors in the polyacrylate host substrate material. The substrate material is exposed to the UV lamp for approximately two to ten minutes, allowing the Y₂₋ₓSiO_{5:x}Ce and In₁₋ₓBO_{3:x}Eu phosphors to charge. The UV lamp is then turned off. The Y₂₋ₓSiO_{5:x}Ce and In₁₋ₓBO_{3:x}Eu phosphors in the polyacrylate host material then emit visible light (104) anywhere from about three nanoseconds to about fifteen minutes. The Y₂₋ₓSiO_{5:x}Ce phosphors emit blue light, having a wavelength of about 400 nm, and the In₁₋ₓBO_{3:x}Eu phosphors emit yellow light, having a wavelength of about 588 nm. The combined visible light from the phosphors generates white light, producing a brighter appearance for the polyacrylate material.

Efforts have been made to ensure accuracy with respect to numbers used (e.g., amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other examples set forth herein will come to mind to one skilled in the art to which this subject matter pertains having the benefit of the teachings presented in the foregoing descriptions and the associated drawings. Therefore, it is to be understood that the subject matter is not to be limited to the specific examples disclosed and that modifications and other examples are intended to be included within the scope of the appended claims. Although specific terms are employed herein, they are used in a generic and descriptive sense only and not for purposes of limitation.

1. A method for improving color stability of a synthetic polymer composition, comprising:
exposing a synthetic polymer host material comprising one or more inorganic phosphor dopants to UV light;
wherein said one or more inorganic phosphor dopants in said synthetic polymer host material absorb said UV light and then emit said UV light as down-converted visible light.

2. The method of claim 1, wherein absorption of said UV light by said one or more inorganic phosphor dopants reduces photo-oxidation of said synthetic polymer host material.

3. The method of claim 1, wherein said visible light emitted by said one or more inorganic phosphor dopants produces a brighter appearance for said synthetic polymer composition.

4. The method of claim 1, wherein said synthetic polymer host material comprises two or more inorganic phosphor dopants, wherein the down-converted visible light emitted by said two or more inorganic phosphor dopants combines to yield white or off-white light.

5. The method of claim 1, wherein said synthetic polymer host material comprises three or more inorganic phosphor dopants, wherein the down-converted visible light emitted by said three or more inorganic phosphor dopants combines to yield white or off-white light.

6. The method of claim 1, wherein said UV light absorbed by said one or more inorganic phosphor dopants has a wavelength between about 160 nm and 380 nm.

7. The method of claim 1, wherein said synthetic polymer host material is a thermoplastic or thermoset.

8. The method of claim 7, wherein said synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.

9. The method of claim 1, wherein said one or more inorganic phosphor dopants are a metal oxide or metal fluoride comprising a rare earth ion selected from the group consisting of Pr³⁺, Ce³⁺, Eu³⁺; Eu²⁺, Gd³⁺, Tb³⁺, and Dy³⁺, or a combination thereof.

10. The method of claim 9, wherein said metal oxide is selected from the group consisting of silicates, phosphates, borates, oxides, oxynitrides, oxysulfides, and aluminates, or combinations thereof.

11. A synthetic polymer composition comprising:
a synthetic polymer host material comprising one or more inorganic phosphor dopants, wherein said one or more inorganic phosphor dopants in said synthetic polymer host material emit down-converted visible light upon exposure to UV light; and
wherein the synthetic polymer composition exhibits mechanical and flammability properties comparable to that of a synthetic polymer composition without said one or more inorganic phosphor dopants.

12. The synthetic polymer composition of claim 11, wherein said synthetic polymer host material is a thermoplastic or thermoset.

13. The synthetic polymer composition of claim 12, wherein said synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.

14. The synthetic polymer composition of claim 11, wherein said one or more inorganic phosphor dopants are a metal oxide or metal fluoride comprising a rare earth ion selected from the group consisting of Pr³⁺, Ce³⁺, Eu³⁺; Eu²⁺, Gd³⁺, Tb³⁺, and Dy³⁺, or a combination thereof.

15. The synthetic polymer composition of claim 14, wherein said metal oxide is selected from the group consisting of silicates, phosphates, borates, oxides, oxynitrides, oxysulfides, and aluminates, or combinations thereof.

16. A method for preparing a synthetic polymer composition comprising:
contacting a synthetic polymer host material with one or more inorganic phosphor dopants to prepare an inorganic phosphor-doped synthetic polymer material, wherein said one or more inorganic phosphor dopants in said inorganic phosphor-doped synthetic polymer material are capable of absorbing UV light and then emitting said UV light as down-converted visible light.

17. The method of claim 16, wherein said synthetic polymer host material is a thermoplastic or thermoset.

18. The method of claim 17, wherein said synthetic polymer host material is selected from the group consisting of tetrafluoroethylene, polyvinyl fluoride, polyurethane, polyester, epoxy, phenolic, vinyl ester, polyamide, polyamide-imide, polyether imide, polyvinylchloride, polyether ketone ketone, polycarbonate, polyphenylsulphone, polymethylmethacrylate, polyacrylate, and benzoxazine.

19. The method of claim 16, wherein said one or more inorganic phosphor dopants are a metal oxide or metal fluoride comprising a rare earth ion selected from the group consisting of Pr³⁺, Ce³⁺, Eu³⁺, Eu³⁺, Gd³⁺, Tb³⁺, and Dy³⁺, or a combination thereof.

20. The method of claim 16, wherein the synthetic polymer composition prepared exhibits mechanical and flammability properties comparable to that of a synthetic polymer composition without said one or more inorganic phosphor dopants.
